(19) United States
(12) Patent Application Publication
(10) Pub. No.: US 2005/0055282 A1
(43) Pub. Date: Mar. 10, 2005

(54) Method and system facilitating the retrieval of lost articles

(76) Inventors: Judith Ackerman, W. Long Branch, NJ (US); Cindy A. Mims, Interlaken, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/900,533

(22) Filed: Jul. 28, 2004

Related U.S. Application Data
(60) Provisional application No. 60/491,173, filed on Jul. 30, 2003.

(51) Int. Cl. G06F 17/60

(52) U.S. Cl. 705/26

(57) ABSTRACT

The present invention is a system and method facilitating the return of lost articles in which articles are marked by a unique identifier associated with a particular owner who contracts with a service provider. The finder of a lost article contacts the service provider to receive therefrom appropriate shipping containers and, upon successful return of the lost article, a reward for returning the lost article.

### CROSS-REFERENCE TO RELATED APPLICATION

This application claims the benefit of U.S. Provisional Patent Application Ser. No. 60/491,173 filed on Jul. 30, 2003 and incorporated herein.

### TECHNICAL FIELD

The invention relates generally to systems and methods facilitating the return of lost articles.

### BACKGROUND OF THE INVENTION

Presently, articles lost by their owner are typically never returned, since the finder of the lost article has no idea who the owner is and, further, no incentive to make the effort to return the article.

### SUMMARY OF THE INVENTION

These and other deficiencies of the prior art are addressed by the present invention of a system and method facilitating the return of lost articles. The subject invention is adapted, in one embodiment, to a system wherein articles are marked with a unique identifier, which identifier is associated with a particular owner. The owner contracts with the service provider (e.g., Always Found) to facilitate return of the article should the article become lost. Return is effected by the finder of the lost article contacting Always Found via telephone or electronic mail to report the finding of the lost article, at which time arrangements are made for the return of the lost article to its owner in exchange for an incentive.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of billing and other interactions associated with an embodiment of the present invention; and

FIG. 2 depicts a flow diagram of a methodology according to an embodiment of the present invention.

### DETAILED DESCRIPTION OF THE INVENTION

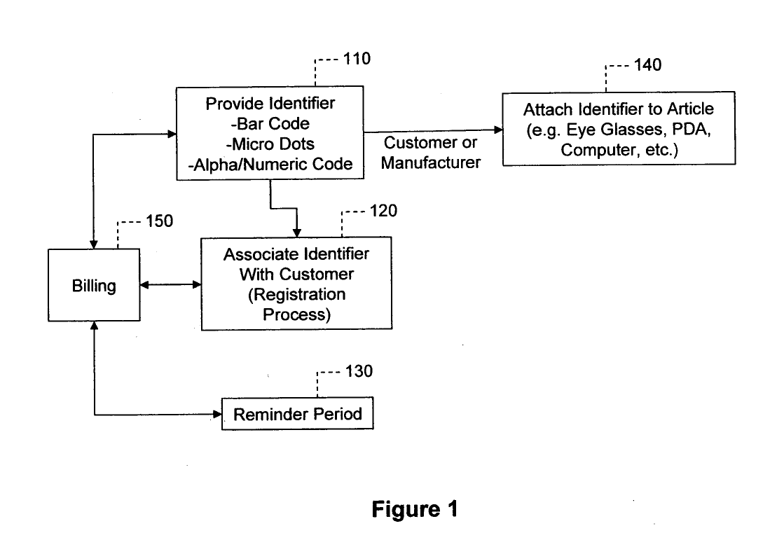

FIG. 1 depicts a high level block diagram of billing and other interactions associated with an embodiment of the present invention. Specifically, at step 110, an identifier is provided to a user or owner. The identifier comprises one or more of a bar code, microdots, an alpha, numeric, or alphanumeric code and the like. At this point, the owner may comprise a customer, end user or the manufacturer of the article. At step 120, the identifier is associated by a service provider with the particular customer using a registration process. A customer comprises the end user of the article by himself or in conjunction with a manufacturer. The identification step 110 and association step 120 are each, optionally, associated with respective billings 150. After an initial period, an optional renewal period 130 requires an additional fee and/or billing event. At step 140, after receiving the identifier, the identifier is attached to the article (e.g., eyeglasses, a PDA computer and the like).

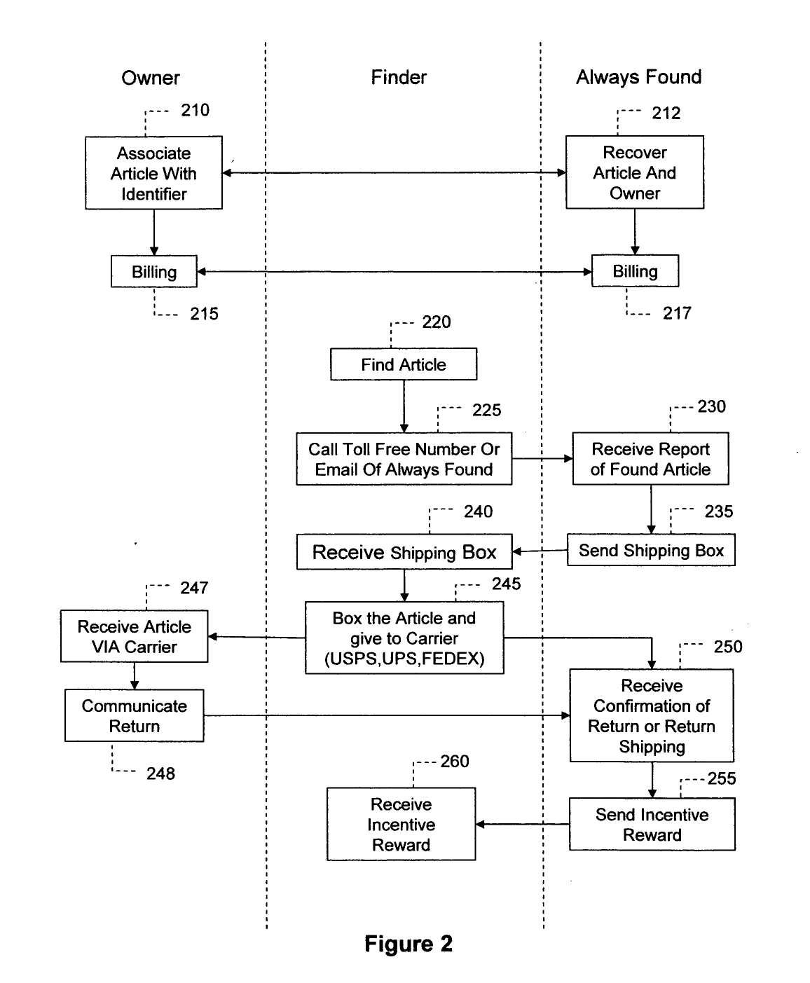

FIG. 2 depicts a flow diagram of a methodology according to an embodiment of the present invention. The actions described below with respect to FIG. 2 are associated with an owner, a finder, and the service provider (i.e., Always Found). The steps associated with the owner are steps 210, 215, 247 and 248; the steps associated with the finder are steps 220, 225, 240, 245 and 260; and the steps associated with the service provider are 212, 217, 230, 235, 250 and 255.

At step 210, an article such as eyeglasses or a PDA is associated with a particular identifier. At step 212, the service provider interacts with the owner to register the article and, if necessary, the owner, in its system. At steps 215 and 217, the owner and service provider, respectively, interact in a billing process. At this point, the article is registered with the system and all initial billing matters between a system provider and owner are concluded.

At step 220, a finder finds the article and at step 225 the finder calls a toll free number or contacts via e-mail the service provider. At step 230, the service provider receives the report of the article being found from the finder. At step 235, the service provider forwards a shipping box and other instructions to the finder. At step 240, the finder receives the shipping box and, at step 245, boxes or encloses the article in the shipping box and gives the shipping box to a carrier such as the United States Postal Service, UPS, FedEx and the like for shipment to the owner. At step 247, the owner receives the article via the carrier, and at step 248, communicates the fact that the article was returned to the service provider. At step 250, the service provider receives confirmation from either the owner (at step 248) or finder (via step 245) that the article has been received or shipped, respectively. At step 255, the service provider sends an incentive or reward to the finder and, at step 260, the finder receives the incentive/reward. The incentive or reward may comprise discount coupons, credits, frequent flyer miles, free food coupons or any other incentive sufficient to encourage the finder to perform the good deed of returning the lost article to the owner.

Always Found™ was established as an eyewear recovery system whereby lost eyeglasses are found and returned to the rightful owner.

How Always Found™ (AF) works in one embodiment:

I: Recovery Phase
Mr. Smith has purchased eyeglasses, and these glasses registered with Always Found™.
Mr. Smith loses his glasses, and then contacts AF that his are lost. Jane Doe finds Mr. Smith's glasses, sees the AF toll-free number on the frame and calls AF. AF sends Ms. Jane Doe a shipping box in which she places the pair of glasses and the USPS picks up the package and returns the glasses to AF. Or, Jane Doe goes to the USPS and drops off the found pair of glasses. USPS will then return the glasses to AF.
AF matches the Data Base with the information contained in the glasses (either using Data Dot technology or some similar identifying technology.
AF then notifies Mr. Smith that his glasses have been found and are being returned to him.
AF sends Jane Doe her gift incentive certificate.
   Identification Tag:
Either Data Dot technology or something similar from another manufacturer will serve as an ID tag. This tag will be comfortable, unobtrusive and durable. Another “logo tag” will be on eyeglasses or other items that will include:
the AF logo and [call] 1-866-IsFound security label.
   How our Always Found™ system functions (the front end system, or process of AF)

AF sells controlled ID Kits to Optical Stores.

A consumer joins AF program at the eyeglass POS or, for currently owned eyewear or other items at a Mall Kiosk.

The customer receives an AF Kit with the identification technology included

The store email/sends completed application to AF

Consumer calls to activate the program and receives confirmation # and leaves a phone #

Confirmation # is activated and awaits application match. Applications not receive are activated by a call to the consumer.

Applications received an matched to Consumer Confirmation Number (CCN)

Date entry complete and then there is

Annual Renewal to maintain data integrity

1. A method, comprising:
registering an article in exchange for a fee;
providing a shipping box in response to a found article report; and
providing a reward in response to a returned article confirmation.

2. The method of claim 1, wherein:
said found article report is received from a finder of said article.

3. The method of claim 1, wherein:
said found article report is received via at least one of a telephonic communication and an electronic mail communication.

4. The method of claim 1, wherein:
said returned article confirmation is provided by an owner of said article.

5. The method of claim 1, wherein:
said step of registering comprises associating said article with identification indicia adapted to be affixed to said article.

6. The method of claim 5, wherein:
said indicia comprises a microdot.

7. The method of claim 1, wherein said fee is associated with an initial time period, said method further comprising:
maintaining said registration for an additional time period in exchange for a second fee.
